(19) United States
(12) Patent Application Publication
(10) Pub. No.: US 2008/0204420 A1
(43) Pub. Date: Aug. 28, 2008

(54) LOW RELIEF TACTILE INTERFACE WITH VISUAL OVERLAY

(75) Inventors: Anthony Dunnigan, Berkeley, CA (US); Eleanor G. Rieffel, Mountain View, CA (US)

Correspondence Address: SUGHRUE MION, PLLC, 2100 Pennsylvania Avenue, N.W., Washington, DC, 20037, US

(73) Assignee: FUJI XEROX CO., LTD., Tokyo (JP)

(21) Appl. No.: 11/680,474

(22) Filed: Feb. 28, 2007

(51) Int. Cl. G06F 3/041

(52) U.S. Cl. 345/173

(57) ABSTRACT

Described is a method and a system for providing user interaction with various devices that incorporates adaptable visual and haptic stimuli. Both the visual and tactile elements of this user interface are aligned with each other and are animated in such a way as to convey more information to the user of such a system than is possible with traditional user interfaces. An implementation of the inventive user interface device includes a flexible and/or stretchable two-dimensional (2D) display membrane covering a set of moving parts, forming a hybrid two-dimensional (2D) and three-dimensional (3D) user interface. The flexible display membrane provides detailed imagery, while the moving parts provide a low relief tactile information to the user. Both the detailed imagery and the low relief tactile information are coordinated together as to the timing, to enable a coordinated user interface experience for the user. Optionally, various sound affects may also be provided, in a time-synchronized manner with respect to the imagery and the tactile information.

### DESCRIPTION OF THE INVENTION

1. Field of the Invention

This invention generally relates to interfaces and, more specifically, to tactile user interfaces.

2. Description of the Related Art

Recently, there have been considerable efforts aimed at enhancing user experience associated with user interaction with various devices, such as computers. To this end, there have been developed pushpin user interfaces which enable simulation of various three dimensional (3D) shapes. These interfaces are primarily directed to providing an accurate depiction of 3D objects and the physics that governs them, often with the purpose of augmenting virtual reality. Because of their complexity, the existing pushpin interfaces are expensive and, thus, are not suitable for most users.

In addition, the existing technology fails to provide methods for rendering accurate visual representation of the simulated 3D shapes, which negatively reflects on the overall user experience. Specifically, conventional systems often rely on projectors to render visual aspects of the 3D shapes. As would be appreciation by persons skilled in the art, a user's hand can block images in those systems. Often, the projected image ends up being visible on the hand of the user. This disconnects the 2D and 3D layers from each other, essentially ruining the intended effect.

Finally, the use of pushpins, without any overlying material, requires very high degree of tactile resolution, leading to a high degree of complexity and the prohibitive cost of the existing systems, which in fact is not required for a user interface to provide a satisfactory user experience.

Thus, what is needed is a system and an associated method that would facilitate complex interactions and provide a satisfactory user experience via a simple user interface.

### SUMMARY OF THE INVENTION

The inventive methodology is directed to methods and systems that substantially obviate one or more of the above and other problems associated with conventional tactile user interfaces.

In accordance with one aspect of the inventive methodology, there is provided a user interface device including a flexible display membrane covering a plurality of moving parts. The flexible display membrane of the inventive user interface is operable to provide imagery to the user. The moving parts of the inventive interface are operable to provide a low relief tactile information to the user, such that the imagery and the low relief tactile information are coordinated together to enable a coordinated user interface.

In accordance with another aspect of the inventive methodology, there is provided a universal remote control unit, which is operable to control an external controlled device. The inventive universal remote control unit includes at least one button, which incorporates a flexible display membrane covering a plurality of moving parts. The aforesaid flexible display membrane is operable to provide imagery to the user and the moving parts are operable to provide a low relief tactile information to the user. The imagery and the low relief tactile information are coordinated together to enable a coordinated user interface and the look and feel of the button changes according to an identity of the external controlled device.

In accordance with yet another aspect of the inventive methodology, there is provided a computer programming product for controlling a user interface device. The inventive computer programming product, when executed by one or more processors causes the one or more processors to cause a flexible display-membrane arranged to cover a plurality of moving parts to provide an imagery to the user. The inventive computer programming product further causes the moving parts to provide a low relief tactile information, such that the imagery and the low relief tactile information are coordinated together to enable a coordinated user interface.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary embodiment of the inventive user interface device.

FIG. 2 illustrates an exemplary three-dimensional (3D) shape and an associated hybrid 3D/2D representation of a vehicle.

FIG. 3 illustrates an exemplary embodiment of a computer platform upon which the inventive system may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

An implementation of the inventive user interface device includes a flexible and/or stretchable two-dimensional (2D) display membrane covering a set of moving parts, forming a hybrid two-dimensional (2D) and three-dimensional (3D) user interface. The flexible display membrane provides visual imagery, while the moving parts provide a low relief tactile information to the user. Both the visual imagery and the low relief tactile information are coordinated together as to the timing, to enable a coordinated user interface experience for the user.

The hybrid two-dimensional (2D) and three-dimensional (3D) user interface in accordance with embodiments of the inventive methodology allow for new kinds of human interactions with computers. An inventive hybrid user interface gives a better representation of mechanical systems and system latency. By blending a specific type of 2D (photo realistic) and 3D (simple low-relief) information and animating it over time, the inventive concept creates a 3D interface that requires much less 3D deformation of the outer surface than other pushpin (or similar) interfaces. By blending two imperfect representations, one tactile and one visual, the interfaces described herein allow the user to leverage spatial, tactile and visual memory and perception. Specifically, the inventive hybrid user interface, by mimicking analog controls as closely as possible, gives users a more natural interaction with the system or devices being controlled.

In accordance with one embodiment of the invention, there are provided methods by which user interfaces with variations in tactile as well as visual properties can be created simply by programming a single hardware device. These inventive methods allow for easy redesign of physical user interfaces and instant reconfiguration of physical interfaces as the devices, applications, users, and tasks with which the interface interacts changes.

An embodiment of the inventive concept involves methods and systems for providing interaction with a computer that incorporate both visual and haptic stimuli. In one embodiment of the invention, the tactile portion of the inventive interface takes the form of a low relief representation of objects including knobs, buttons and information panes. In this embodiment, the objects are rendered in a style that is closely related to bas relief. Bas-relief is a method of sculpting, which entails carving or etching away the surface of a flat piece of stone or metal. The word is derived from the Italian basso rilievo, the literal translation meaning raised contrast. To explain simply, it is a sculpture portrayed as a picture. In accordance with this method, the portrayed image is somewhat raised above the background flat surface.

It should be noted that the objects simulated by an embodiment of the inventive interface are only rendered with enough height and detail to convey their general shape and position. A visual image representative of the visual aspects of the objects being represented in low relief is overlaid onto the surface displaying the inventive user interface. This image is rendered in a style similar to Trompe-l'œi. Trompe-l'œil is French for “trick the eye” from tromper—to deceive and l'œil—the eye. It is an art technique involving extremely realistic imagery in order to create the optical illusion that the depicted objects really exist.

In an embodiment of the inventive system, both layers of information (visual and tactile) are animated and synchronized, preferably, to within two milliseconds of each other. In addition, the audio cues may be provided to enhance the user experience. These audio representations should also be appropriately synchronized with the visual and tactile information. Simple physics models, similar to those used in video games, are used to govern the behavior of the inventive hybrid 2D/3D objects. It is well-known that the user's perception of a device is influenced by the operation of the controls for that device. By making use of this fact, switches and knobs can be generated that allow for a greater feeling of control over a device or devices while setting realistic performance expectation in the user.

The inventive 2D/3D hybrid user interface device provides for greater flexibility when creating user interfaces for conference rooms or other complex environments. These interfaces can be used to control remote objects just as they can be used to control devices in the immediate environment. For example, in a conference room or living room instead of having many remotes or a single universal remote with fixed numbers, size and layout of buttons, the inventive technology may be used to implement a universal remote with exactly the number of buttons needed, laid out in a way appropriate to the devices at hand, and which can be easily changed to as devices which it controls are added or removed. In addition, the inventive technology enables user customization of control interfaces, enabling the user to adjust the position, look and feel of the interface elements. Specifically, by way of example, in a remote control, the user may use the software to adjust the location and shape of the buttons.

In addition to providing flexible and adaptable button layout, the inventive methodology supports a variety of physical interactions including knobs, rocker switches, dials, and sliders. Thus, the type of physical input can be aligned with both device capabilities and user preferences. Both the tactile and visual aspects of the interface can change not only with changes in devices or user but also as the user changes tasks or levels within a task so that only the appropriate switches and dials are shown at a given time and optimal layout can be achieved.

Furthermore, the haptic feedback provided by the system would provide a clearer representation of the latency inherent in these environments. For the same reasons more direct device control based on this concept of a 2D/3D hybrid user interface would provide a more authentic user experience. In both cases, the brain's ability to construct a mental map of the interface would allow for interactions that require less focused attention be paid to the layout of the user interface. In addition, visually impaired persons would be able to use the same user interface as sighted persons.

Because of its adaptability, the inventive interface can also provide stronger forms of feedback than traditional user interfaces can provide. For instance, in one exemplary embodiment, if the user is trying to set a parameter out of range, instead of getting an error message the user would feel the slider stop at the end of the range. Furthermore, the interface could provide alerts by growing a prominent button suggesting that the user perform a certain task.

The inventive hybrid 2D/3D user interface also provides interesting possibilities for interacting with traditional data. Text or information windows could be slid across the control surfaces in a very natural way. Such windows cold be dismissed or minimized by simple pressing them into the background. Any number of simple interactions can be imagined for accomplishing fairly complex organizational tasks.

The adaptability can also be used to hide functionality unless the person has the correct security key. For example, without a security key the interface could look blank, without any raised surfaces or visuals, as well as being non-functional, or without a key only some of the functionality is made available and only interface objects corresponding to that functionality are shown such that no hint is given as to additional functionality.

The inventive user interface is well suited to situations where complex and/or varied tasks must be accomplished within a confined space from small conference rooms or machine rooms to submarines or space ships. By providing only those controls that are needed to accomplish a given task valuable real estate is not wasted on inappropriate or seldom used but saved for critical functionality.

Such a haptic interface could also be applied to the field of biology and medicine, for example as an interface for laparoscopic surgery. More generally such an interface has advantages for the manipulations of small objects, particularly in nanotechnology (X). By representing nanoscale objects on a macro scale and then limiting the movement of these “avatars” to simulate the capabilities of the devices actually in contact with them this interface provides simpler, more intuitive interactions.

Now, an exemplary implementation of the inventive user interface will be described in detail.

### Low Relief 3D Layer

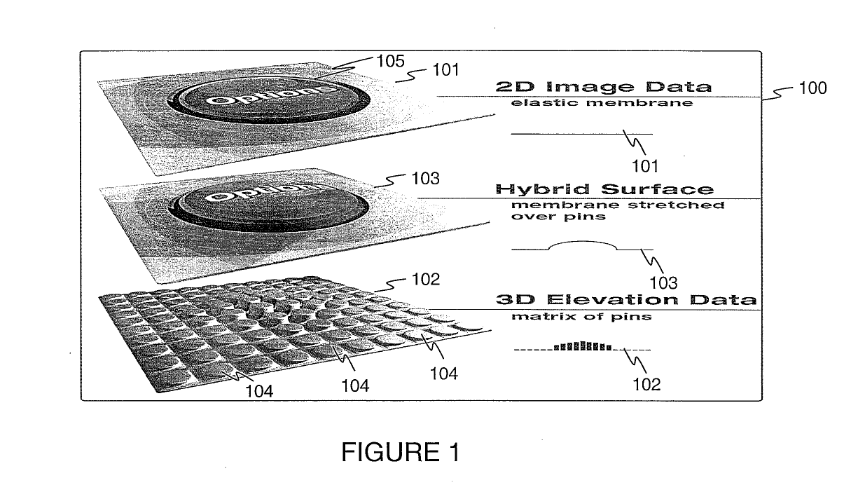

As stated above, the inventive interface 100 provides a hybrid surface 103, which consists of a low relief 3D layer 102 overlaid with a 2D image layer 101, as shown in FIG. 1. The aforesaid 3D layer may be implemented using a fairly coarse matrix of pins 104, which provide enough resolution to produce a simple 3D representation 102 of objects including knobs, buttons, information panes and the like. These pins 104 move up and down based on a combination of the user's input and the state of the system being controlled by the user interface. The pins 104 may be moved using any known or later developed mechanical or electrical actuation method, such as magnetic actuation or piezoelectric actuation. To this end, the pins 104 are mechanically coupled to the aforesaid actuators in an appropriate manner. For example, the inventive system may be implemented using pins/pistons with a total footprint of not more than a few millimeters. The pin actuators can be electrically controlled by the controller module associated with the interface device. Thus, the shape of the 3D structure simulated by the pin matrix 104 may be controlled by a software application executing on the controller associated with the user interface or on the main CPU of user's personal computer.

The user's motion across multiple pins as well as the “pressing” of any group of pins is tracked using one or more sensors. These sensors detect user's interaction with the elements of the user interface and send the appropriate signals to the associated control device. The aforesaid sensors may be implemented in a form of electrical or mechanical touch sensors.

Other embodiments of the invention user other methods for creating the low relief 3D layer, which could include a matrix of shapes that are distorted by heat, electricity, pressure of some other force. Such a distortion must occur quickly, provide sufficient force to allow for a realistic interaction with the user and be completely reversible.

It should be noted that in many cases, the inventive system need not create elaborate detailed 3D shapes in order to provide acceptable user experience. The feel of the 3D shapes created by the interface may be abstracted sufficiently to provide a minimum level of detail necessary for user interaction. In addition, the low relief tactile information created by the aforesaid pin matrix may persist over extended periods of time.

### Detailed 2D Layer

This layer could be implemented as an opaque flexible and/or stretchable membrane that covers the 3D layer and may be physically adhered to some or all of its pins. This membrane provides a smooth surface for displaying image data as well as “smoothing” out the course grid that the pins will create. The detailed, animated, video image displayed upon this layer will contain any important text or other data that the user needs to focus on as well as contextual information such as the materials that the simulated 3D objects are made of (wood, metal and etc.) This peripheral information will augment the simplified 3D representation of control objects provided by the 3D layer. The detail in this layer also includes much of the height and shape information for the objects in the 3D layer. This detailed visual representation of the user interface is rendered and synchronized to the motion of the 3D layer.

In one embodiment of the invention, the imagery could be displayed via Lumilive LED fabric available from Phillips Corporation. As well known in the art, Lumalive fabrics feature flexible arrays of colored light-emitting diodes (LEDs) fully integrated into the fabric—without compromising the softness or flexibility of the cloth. These light emitting textiles make it possible to create materials that can carry dynamic messages, graphics or multicolored surfaces. These properties make the Lumilive LED fabric an ideal material to drape over the inventive minimally distorted 3D layer. In other implementations, flexible LCD screens and ePaper pages could also be flexible enough to allow for some deformation to occur. These options offer the potential for extremely high-resolution imagery of the 2D layer. In yet another embodiment of the invention, the 2D image representation may be created using a flexible fiber optic matrix coupled to appropriate light source.

By incorporating a layer that serves as the actual source of the image data, the inventive system provides a more persistent image than conventional systems that rely on projectors. As would be appreciation by persons skilled in the art, a user's hand can block images in those systems. Often, the projected image ends up being visible on the hand of the user. This disconnects the 2D and 3D layers from each other, essentially ruining the intended effect. The inventive system's stronger visual persistence will enhance the perceived solidity of our 2D/3D hybrid objects.

The inventive flexible membrane addresses one of the flaws inherent in the pin based 3D objects. It provides a single molded surface that allows the pins to be placed further apart without degrading the solid feel of the 3D objects represented by them. The finger's sense of touch is so fine that in order for a simple matrix of pins to feel “solid” each pin must be placed within 0.9 millimeters of each other. The inventive 2D layer overlaying the pins allows the user to perceive shapes generated by the 3D layer as solid even though the 3D grid used by the inventive system is much courser.

It should be noted that the level of detail of the 2D layer is limited by the technology used to generate it. For example, an embodiment of the inventive system implemented using LED technology will be much courser than an embodiment implemented using LCD technology. That said, a certain minimum resolution must be maintained for the inventive user interface to be useful. However, there is no maximum resolution limitation for the 2D visible layer. In fact, it is desirable to impart as much visual information to the user as possible. The usefulness of the of the inventive user interface increases as the resolution of the visual layer improves, especially when combined with information from the tactile 3D layer. The tactile 3D layer, described herein, does have a maximum desired resolution. Specifically, it is desirable to impart the minimum amount of tactile information possible while still describing the position and boundaries of shapes. Also, if, for some reason, the tactile layer were to fail the visual layer would still carry enough information to allow the inventive user interface to be useful. This is not true of a failure of the visual layer.

### 2D/3D Hybrid User Interface

In an embodiment of the invention, both the 2D and 3D layers are driven by a TFT type electronic driver circuit. The information represented by both layers are synchronized quite. closely and preferably within two milliseconds of each other. The elements of the 2D and 3D layers are synchronized with respect to motion, position, size, look and feel. The latency of the user interface must remain constant and must be held to under 200 milliseconds. The combination of the aforesaid two layers provides the user with a simple but information rich user interface that can be customized based on any number of system or user requirements.

Blending a specific type of 2D (photo realistic) and 3D (simple and low-relief) information and animating it over time, results in a ,3D interface that requires much less 3D deformation of the outer surface than other pushpin (or similar) interfaces. By blending two imperfect representations, one tactile and one visual, the interfaces described in this invention allow the user to leverage spatial, tactile and visual memory and perception.

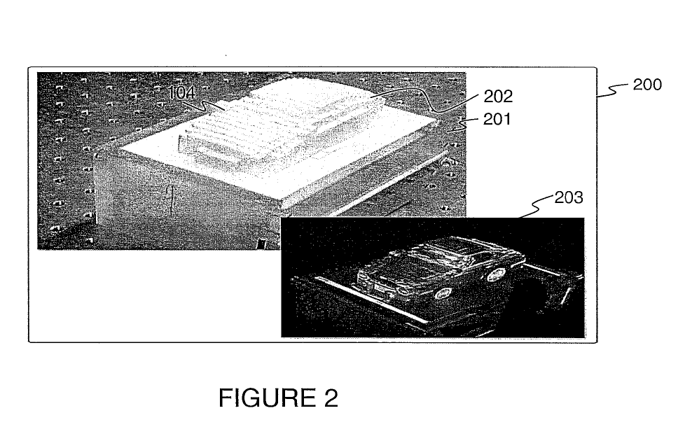

FIG. 2 illustrates an exemplary three-dimensional (3D) shape 202 and an associated hybrid 3D/2D representation 203 of a vehicle. The 3D shape 202 is created by an embodiment of the inventive interface 201 using the matrix of pins 104. The 3D/2D representation 203 incorporates the 3D shape 202 with a corresponding 2D image overlaid. As would be appreciated by one of skill in the art, the inventive system achieves a realistic depiction of the intended object.

### First Exemplary Implementation

A first exemplary implementation consist of matrix of pins that are displaced along their horizontal axis to form a simple button shape and covered by a flexible membrane onto which the visuals for the interface will be projected using vLight and/or Cubic Vision methods. The prototype could be used to test the level of detail necessary to represent the 3D objects in this user interface by comparing various diameters and arrangements of pins. Changing the amount that the simple button shape displaces the pins will test the level of relief needed to represent these 3D elements.

### Second Exemplary Implementation

The second exemplary implementation is in a form of a simple slide show control interface. The exemplary interface features two simple button shapes; “previous” and “next” arrows. In the user interface's “off” state no buttons are visible. In the “first slide” state only the “next” button is visible. In the “presentation” state both “previous” and “next” buttons are visible. Finally, in the “last slide” state only the “previous” button is visible. For this implementation, only the simple button shapes will need to be actuated and pressure sensitive, the pins serve only to deform the flexible membrane. The Phillips's Lumilive fabric, which is commercially available, is used as the 2D layer for this implementation. Alternatively, another method of representing the 2D information that was used in the first exemplary implementation could be used for the second exemplary implementation as well.

### Third Exemplary Implementation

The third exemplary implementation is an adaptable remote control having buttons and other control elements to suit the specific controlled device, mission or application. The implementation includes a control area where specific control elements are formed. The control elements may include one or more buttons, sliders, dials and/or rocker switches. The look, location and feel of the specific control elements produced by the third implementation may depend on the device or application being controlled and on the preferences of the user. Specifically, the user may choose the specific types of controls that he or she prefers. For example, the user may choose button over switch. The user may also choose the specific location of the controls to suite, for example, the size of the user's hand. The implementation inventive system generates the controls specified by the user without regard to preferences of other users who have used the system. The system may further store the user personalization information enabling user preference to be quickly restored for different users. The invention may generate the controls only when those controls the required in the context of the user interaction with the controlled functionality.

### Other Features

In one exemplary embodiment, the inventive interface is configured to provide force feedback to the user. In addition, the inventive system may be used to simulate the texture of the intended objects by arranging the pins of the 3D representation in a predetermined manner.

### Exemplary Computer Platform

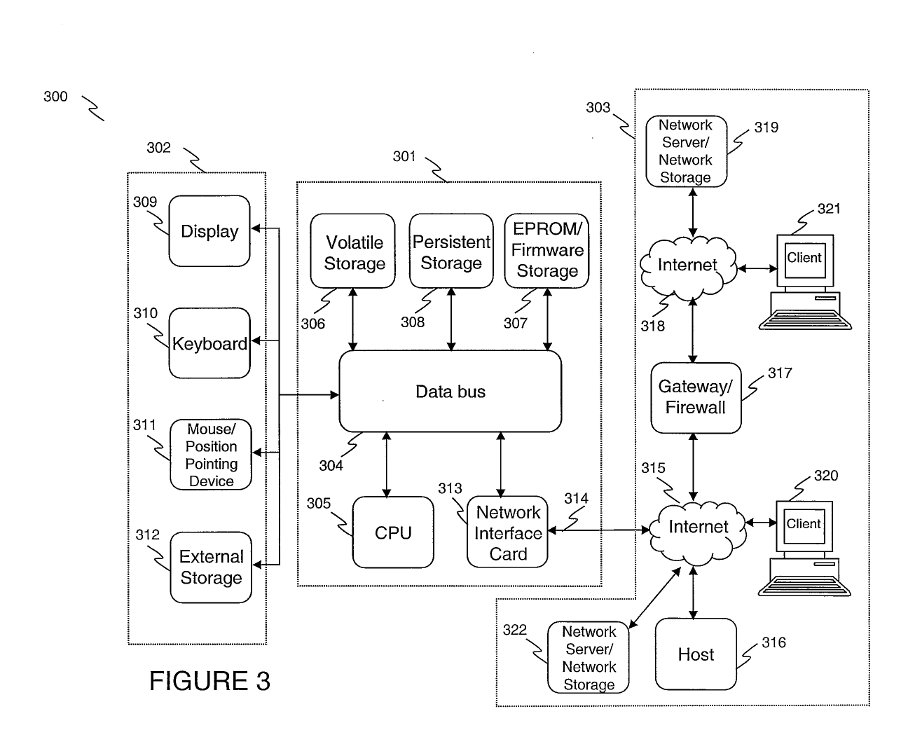

FIG. 3 is a block diagram that illustrates an embodiment of a computer/server system 300 upon which an embodiment of the inventive methodology may be implemented. It should be understood that apart from the computer system shown in FIG. 3, the inventive user interface may be utilized in connection with various other types of devices, such as controllers for conference rooms, living rooms, machine rooms, space ships and submarines, surgery, nanomanipulation, as well as gaming consoles. While some of those control systems may include some of the components of the computer system 300 described below, it should be understood that none of the below-described components is necessary for the implementation of the inventive concept. Therefore, the below description of the computer system 300 is provided for as an example only and should not be considered to be limiting in any way.

The exemplary system 300 shown in FIG. 3 includes a computer/server platform 301, peripheral devices 302 and network resources 303.

The computer platform 301 may include a data bus 304 or other communication mechanism for communicating information across and among various parts of the computer platform 301, and a processor 305 coupled with bus 301 for processing information and performing other computational and control tasks. Computer platform 301 also includes a volatile storage 306, such as a random access memory (RAM) or other dynamic storage device, coupled to bus 304 for storing various information as well as instructions to be executed by processor 305. The volatile storage 306 also may be used for storing temporary variables or other intermediate information during execution of instructions by processor 305. Computer platform 301 may further include a read only memory (ROM or EPROM) 307 or other static storage device coupled to bus 304 for storing static information and instructions for processor 305, such as basic input-output system (BIOS), as well as various system configuration parameters. A persistent storage device 308, such as a magnetic disk, optical disk, or solid-state flash memory device is provided and coupled to bus 301 for storing information and instructions.

Computer platform 301 may be coupled via bus 304 to a display 309, such as a cathode ray tube (CRT), plasma display, or a liquid crystal display (LCD), for displaying information to a system administrator or user of the computer platform 301. Apart from the inventive user interface (not shown), the computer platform 301 may incorporate an input device 310, including alphanumeric and other keys, which is coupled to bus 301 for communicating information and command selections to processor 305. Another type of optional user input device that may be provided is a cursor control device 311, such as a mouse, a trackball, or cursor direction keys for communicating direction information and command selections to processor 304 and for controlling cursor movement on display 309. This input device typically has two degrees of freedom in two axes, a first axis (e.g., x) and a second axis (e.g., y), that allows the device to specify positions in a plane. It should be understood that in an embodiment of the invention, the optional user interfaces 310 and 311 may be replaced entirely with the inventive user interface.

An external storage device 312 may be connected to the computer platform 301 via bus 304 to provide an extra or removable storage capacity for the. computer platform 301. In an embodiment of the computer system 300, the external removable storage device 312 may be used to facilitate exchange of data with other computer systems.

The invention is related to the use of computer system 300 for implementing the techniques described herein. In an embodiment, the inventive system may reside on a machine such as computer platform 301. According to one embodiment of the invention, the techniques described herein are performed by computer system 300 in response to processor 305 executing one or more sequences of one or more instructions contained in the volatile memory 306. Such instructions may be read into volatile memory 306 from another computer-readable medium, such as persistent storage device 308. Execution of the sequences of instructions contained in the volatile memory 306 causes processor 305 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 305 for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks, such as storage device 308. Volatile media includes dynamic memory, such as volatile storage 306. Transmission media includes coaxial cables, copper wire and fiber optics, including the wires that comprise data bus 304. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, a carrier wave as described hereinafter, or any other medium from which a computer can read.

Various forms of computer readable media may be involved in carrying one or more sequences of one or more instructions to processor 305 for execution. For example, the instructions may initially be carried on a magnetic disk from a remote computer. Alternatively, a remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on the data bus 304. The bus 304 carries the data to the volatile storage 306, from which processor 305 retrieves and executes the instructions. The instructions received by the volatile memory 306 may optionally be stored on persistent storage device 308 either before or after execution by processor 305. The instructions may also be downloaded into the computer platform 301 via Internet using a variety of network data communication protocols well known in the art.

The computer platform 301 also includes a communication interface, such as network interface card 313 coupled to the data bus 304. Communication interface 313 provides a two-way data communication coupling to a network link 314 that is connected to a local network 315. For example, communication interface 313 may be an integrated services digital network (ISDN) card or a modem to provide a data communication connection to a corresponding type of telephone line. As another example, communication interface 313 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 313 sends and receives electrical, electromagnetic or optical signals that carry digital data streams representing various types of information.

Network link 313 typically provides data communication through one or more networks to other network resources. For example, network link 314 may provide a connection through local network 315 to a host computer 316, or a network storage/server 317. Additionally or alternatively, the network link 313 may connect through gateway/firewall 317 to the wide-area or global network 318, such as an Internet. Thus, the computer platform 301 can access network resources located anywhere on the Internet 318, such as a remote network storage/server 319. On the other hand, the computer platform 301 may also be accessed by clients located anywhere on the local area network 315 and/or the Internet 318. The network clients 320 and 321 may themselves be implemented based on the computer platform similar to the platform 301.

Local network 315 and the Internet 318 both use electrical, electromagnetic or optical signals that carry digital data streams. The signals through the various networks and the signals on network link 314 and through communication interface 313, which carry the digital data to and from computer platform 301, are exemplary forms of carrier waves transporting the information.

Computer platform 301 can send messages and receive data, including program code, through the variety of network(s) including Internet 318 and LAN 315, network link 314 and communication interface 313. In the Internet example, when the system 301 acts as a network server, it might transmit a requested code or data for an application program running on client(s) 320 and/or 321 through Internet 318, gateway/firewall 317, local area network 315 and communication interface 313. Similarly, it may receive code from other network resources.

The received code may be executed by processor 305 as it is received, and/or stored in persistent or volatile storage devices 308 and 306, respectively, or other non-volatile storage for later execution. In this manner, computer system 301 may obtain application code in the form of a carrier wave.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

Moreover, other implementations of the invention will be apparent to those skilled in the art from consideration of the specification and practice of the invention disclosed herein. Various aspects and/or components of the described embodiments may be used singly or in any combination into a tactile computer interface. It is intended that the specification and examples be considered as exemplary only, with a true scope and spirit of the invention being indicated by the following claims.

What is claimed is:

1. A user interface device comprising a flexible display membrane covering a plurality of moving parts, wherein the flexible display membrane is operable to provide an imagery and the plurality of moving parts are operable to provide a low relief tactile information and wherein the imagery and the low relief tactile information are coordinated together to enable a coordinated user interface.

2. The user interface device of claim 1, wherein the low relief tactile information is coarse three-dimensional tactile information.

3. The user interface device of claim 1, wherein the flexible display membrane comprises a flexible LED fabric operable to display the imagery.

4. The user interface device of claim 1, wherein the flexible display membrane comprises a flexible LCD layer operable to display the imagery.

5. The user interface device of claim 1, wherein the flexible display membrane comprises an ePaper layer operable to display the imagery.

6. The user interface device of claim 1, wherein the flexible display membrane comprises flexible fiber optic matrix operable to display the imagery.

7. The user interface device of claim 1, wherein the imagery and the low relief tactile information are changeable by a software.

8. The user interface device of claim 1, wherein the low relief tactile information provided by the plurality of moving parts is abstracted sufficiently to provide a minimum level of detail necessary for interaction.

9. The user interface device of claim 1, wherein the flexible display membrane is operable to unify surfaces of the plurality of moving parts creating a unified perceived shape.

10. The user interface device of claim 1, wherein the low relief tactile information persist over time.

11. The user interface device of claim 1, wherein elements of the flexible display membrane and the plurality of moving parts are synchronized with respect to motion, position and size.

12. The user interface device of claim 1, wherein the coordinated user interface is adaptable to simulate a physical interface of a controlled device associated with the user interface device.

13. The user interface device of claim 11, wherein the physical interface is one of a group consisting of a button, a slider, a dial and a rocker switch.

14. The user interface device of claim 1, wherein the coordinated user interface is displayed based on a context of the user interaction with a controlled device associated with the user interface device.

15. The user interface device of claim 1, wherein the coordinated user interface comprises a plurality of controls of a controlled device associated with the user interface device.

16. The user interface device of claim 15, wherein a position of at least one of the plurality of controls is determined by a context of the user interaction with the controlled device.

17. The user interface device of claim 15, wherein at least one of the plurality of controls is simulated only when the control is required by a context of the user interaction with the controlled device.

18. The user interface device of claim 15, wherein a position of at least one of the plurality of controls is determined in accordance with user preferences.

19. The user interface device of claim 15, wherein a position of at least one of the plurality of controls is determined in accordance with a context of the user interaction with the controlled device.

20. The user interface device of claim 15, wherein at least one of the plurality of controls is determined by a type of the controlled device associated with the user interface device.

21. The user interface device of claim 15, wherein at least one of the plurality of controls is determined by a function of the controlled device associated with the user interface device.

22. The user interface device of claim 15, wherein at least one of the plurality of controls is changeable remotely by software.

23. The user interface device of claim 15, wherein at least one of the plurality of controls is determined in accordance with preferences of a user using the user interface device.

24. The user interface device of claim 23, wherein the at least one of the plurality of controls is determined independently of preferences of other users.

25. The user interface device of claim 1, wherein the at least one of the plurality of moving parts is actuated by a mechanical actuator.

26. The user interface device of claim 1, wherein the at least one of the plurality of moving parts is actuated by a piezoelectric actuator.

27. The user interface device of claim 1, wherein the plurality of moving parts are operatively coupled to at least one sensor operable to detect user interaction with the user interface device.

28. The user interface device of claim 27, wherein the sensor is a mechanical sensor.

29. The user interface device of claim 27, wherein the sensor is an electronic sensor.

30. The user interface device of claim 1, wherein the flexible display membrane comprises at least one sensor operable to detect user interaction with the user interface device.

31. The user interface device of claim 1, further comprising a sound device operable to generate at least one sound affect in a time synchronized manner with respect to the imagery and the low relief tactile information.

32. The user interface device of claim 1, further comprising a security module operable to receive password information from a user, verify the received password information and enable the coordinated user interface if the received password information has been successfully verified.

33. The user interface device of claim 1, further comprising a security module operable to receive password information from a user, verify the received password information and enable limited functionality of the coordinated user interface if the received password is not successfully verified.

34. A universal remote control unit operable to control an external controlled device, the unit comprising at least one button, the button comprising a flexible display membrane covering a plurality of moving parts, wherein the flexible display membrane is operable to provide an imagery and the plurality of moving parts are operable to provide a low relief tactile information and wherein the imagery and the low relief tactile information are coordinated together to enable a coordinated user interface and wherein a look and feel of the button changes according to an identity of the external controlled device.

35. A computer programming product for controlling a user interface device, the computer programming product being embodied in a computer readable medium, the computer programming product, when executed by one or more processors causing the one or more processors to:
a. Cause a flexible display membrane arranged to cover a plurality of moving parts to provide an imagery; and
b. Cause the plurality of moving parts to provide a low relief tactile information, wherein the imagery and the low relief tactile information are coordinated together to enable a coordinated user interface.

36. The computer programming product of claim 35, further causing the one or more processors to alter the imagery and the low relief tactile information.

37. The computer programming product of claim 35, further causing the one or more processors to synchronize elements of the flexible display membrane and the plurality of moving parts are with respect to motion, position and size.

38. The computer programming product of claim 35, further causing a physical interface of a controlled device associated with the user interface device to be simulated by the flexible display membrane and the plurality of moving parts.

39. The computer programming product of claim 35, wherein the physical interface is one of a group consisting of a button, a slider, a dial and a rocker switch.

40. The computer programming product of claim 35, further causing a plurality of controls of a controlled device associated with the user interface device to be simulated by the flexible display membrane and the plurality of moving parts.

41. The computer programming product of claim 40, further causing a position of at least one of the plurality of controls to be changed in accordance with user preferences.

42. The computer programming product of claim 35, further causing a user interaction with the user interface device to be detected and controlling a controlled device associated with the user interface device based on the detected user interaction.

43. The computer programming product of claim 35, further causing at least one sound affect to be generated in a time synchronized manner with respect to the imagery and the low relief tactile information.

44. The computer programming product of claim 35, further causing:
password information to be received from a user;
the received password information to be verified; and
the coordinated user interface to be enabled if the received password information has been successfully verified.

45. The computer programming product of claim 35, further causing:
password information to be received from a user;
the received password information to be verified; and
limited functionality of the coordinated user interface to be enabled if the received password information has not been successfully verified.
